(19) United States
(12) Patent Application Publication
(10) Pub. No.: US 2020/0201437 A1
(43) Pub. Date: Jun. 25, 2020

(54) HAPTICALLY-ENABLED MEDIA

(71) Applicant: Immersion Corporation, San Jose, CA (US)

(72) Inventors: Jamal SABOUNE, Montreal (CA); Johnny MAALOUF, Laval (CA); Shadi ASFOUR, Montreal (CA); Eric GERVAIS, Montreal (CA)

(21) Appl. No.: 16/230,008

(22) Filed: Dec. 21, 2018

(51) Int. Cl. G06F 3/01; G06F 3/0488; G06K 9/00; G06Q 30/02; G06T 19/00

(52) U.S. Cl. CPC G06F 3/016; G06F 3/013; G06T 19/006; G06K 9/00288; G06Q 30/02; G06F 3/04883

(57) ABSTRACT

Systems, methods, and instructions for rendering haptic effects in connection with marketing content, such as advertisements, are provided. Marketing content is displayed, and a user interaction is detected at or adjacent to the display. Haptic feedback is rendered that corresponds to and further enhances the marketing content. In some configurations, the haptic feedback is rendered at a user device that is communicatively coupled to the display. The haptic feedback is provided in connection with a variety of marketing media (e.g., billboards, tablets, printable media, etc.) and in real world and alternate reality environments.

### FIELD OF INVENTION

The embodiments of the present invention are generally directed to electronic and other media devices, and more particularly, to electronic and other media devices and applications that are configured to render haptic effects.

### BACKGROUND

Electronic device manufacturers strive to produce a rich interface for users. Conventional devices use visual and auditory cues to provide feedback to a user. In some interface devices, kinesthetic feedback (e.g., active and resistive force feedback) and/or tactile feedback (e.g., vibration, texture, and heat) is also provided to the user, more generally and collectively known as “haptic feedback” or “haptic effects.” Haptic feedback can provide additional cues that enhance and simplify user interfaces. Specifically, vibration effects, or vibrotactile haptic effects, may be useful in providing cues to users of electronic devices to alert the user to specific events, or provide realistic feedback to create greater sensory immersion within a simulated or virtual environment.

An increasing number of devices, such as smartphones and tablets, include hardware, such as actuators, for generating haptic effects. Haptic effects, in particular, can enhance the audio/video experience on these example devices. For example, haptic effect accompaniment to an audio/video track can allow a viewer to “feel” an engine roaring in a car, explosions, collisions, and the shimmering feeling of sunlight. Other devices in which a user interacts with a user input element to cause an action also may benefit from haptic feedback or haptic effects. For example, such devices may include medical devices, automotive controls, remote controls, trackpads, and other similar devices. Until now, however, marketing methods have made limited use of haptic feedback.

### SUMMARY OF THE INVENTION

Embodiments of the present invention are generally directed toward electronic and other media devices configured to render haptic feedback. The embodiments of the present invention substantially improve upon the related art.

Systems, methods, and instructions for rendering haptic effects in connection with marketing content, such as advertisements, are provided. Marketing content is displayed, and a user interaction is detected at or adjacent to the display. Haptic feedback is rendered that corresponds to and further enhances the marketing content. In some configurations, the haptic feedback is rendered at a user device that is communicatively coupled to the display. The haptic feedback is provided in connection with a variety of marketing media (e.g., billboards, tablets, printable media, etc.) and in real world and alternate reality environments.

Additional features and advantages of the invention will be set forth in the description which follows, and in part will be apparent from the description, or may be learned by practice of the invention. The advantages of the embodiments of the present invention will be realized and attained by the structure particularly pointed out in the written description and claims hereof as well as the appended drawings. It is to be understood that both the foregoing general description and the following detailed description are exemplary and explanatory and are not intended to limit the invention to the described examples.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 illustrates a block diagram of a haptic enabled touch surface according to an example embodiment of the present invention.

FIG. 2 illustrates a cross-sectional view of a haptic enabled display surface according to an example embodiment of the present invention.

FIG. 3 illustrates a front view of a haptic enabled media surface according to an example embodiment of the present invention.

FIG. 4 illustrates the rendering of haptic effects in an alternate reality environment according to an example embodiment of the present invention.

FIG. 5 illustrates a flow diagram of functionality 500 for rendering haptic feedback in connection with marketing content according to an example embodiment of the present invention.

### DETAILED DESCRIPTION:

In the various embodiments, systems and methods for rendering haptic effects in connection with marketing content, such as advertisements, are provided. In the various embodiments described herein, programmable textures and haptic effects are provided in connection with various marketing content. The embodiments provide haptic effects in connection with a variety of marketing media (e.g., billboards, tablets, printable media, etc.) and in real world and alternate reality environments.

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

In the various embodiments, a variety of user interfaces and methods for using a media device are described. In some embodiments, the media device is a portable device (e.g., a game controller, console, mobile phone, smartphone, tablet, wearable watch, smart eyeglasses, and/or other peripheral). It should be understood, however, that the user interfaces and associated methods may be applied to numerous other devices, such as billboards and printable media (e.g., paper or three-dimensional printable material) as well as personal computers, medical devices, laptops, and the like that may include one or more other physical user-interface devices, such as a keyboard, mouse, trackball and the like.

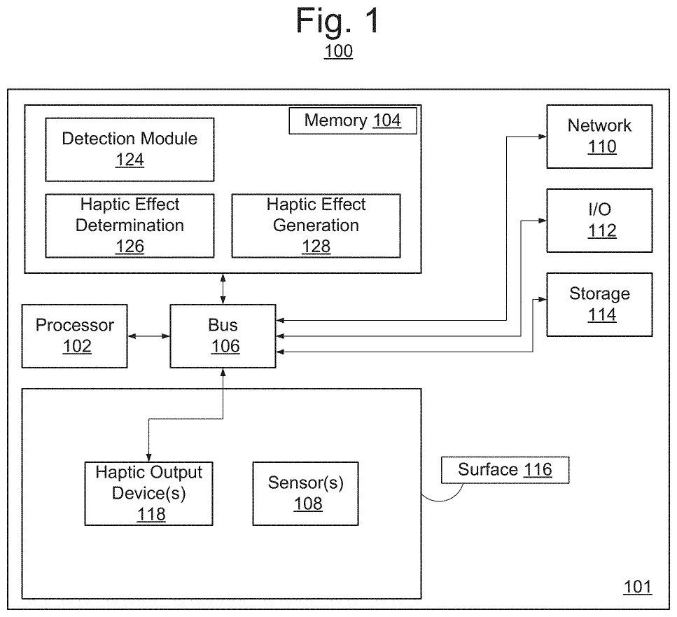

FIG. 1 illustrates a block diagram of a system 100 for a haptic enabled touch sensitive surface according to an example embodiment of the present invention.

As shown in FIG. 1, system 100 includes a computing device 101 having a processor 102 interfaced with other hardware, such as a memory 104, via a bus 106. In this example configuration, computing device 101 further includes one or more network interface devices 110, input/output (“I/O”) interface components 112, additional storage 114, and a touch surface 116.

Touch surface 116 or base device (e.g., a tablet, trackpad, electronic billboard, or printable media) may be integrated with or coupled to computing device 101. Touch surface 116 includes any surface (e.g., touchpad, touchscreen, printable media, etc.) that is configured to sense input of the user. One or more sensors 108 are configured to detect touch at the pressure sensitive areas when one or more objects (e.g., finger, hand, stylus, etc.) contact touch surface 116 and provide appropriate data for use by processor 102. Sensors 108 may be configured to sense either a single touch and/or multiple simultaneous touches on touch surface 116. Alternatively, or additionally, sensors 108 may be configured to sense the proximity or presence of one or more users. Although touch surface 116 is illustrated and described as an example, the embodiments are not limited to touch enabled displays. For example, haptic feedback is provided in connection with a variety of marketing media such as electronic billboards, printable media, etc.

Any suitable number, type, and/or arrangement of sensors 108 can be used. For example, resistive and/or capacitive sensors may be embedded in touch surface 116 and used to determine the location of a touch and other information, such as pressure. In another example, sensors 108 may include optical sensors that are configured to determine the touch positions. In some embodiments, sensors 108 may be configured to detect multiple aspects of the user interaction. For example, sensors 108 may detect the speed and pressure of a user interaction. In yet other embodiments, sensors 108 may include a smart material. Such smart materials include, for example, piezoelectric materials that are configured to produce a voltage signal in response to an applied stress; shape-memory alloys and shape-memory polymers that are configured to produce a deformation in response to a change in temperature or stress; or temperature-responsive polymers that are configured to change shape in response to a temperature change (e.g., temperature change detected by a user's touch).

Haptic output devices 118, in communication with processor 102, may be provided within touch surface 116. Additional haptic output devices 118 may be disposed at touch surface 116 and/or other components of the computing device 101. In some embodiments, haptic output device 118 is configured to output a haptic effect simulating a variety of textures on touch surface 116. For example, a variety of smooth, rough, soft, hard, bumpy, sandy, and other textures may be simulated. In some instances, the perceived coefficient of friction may be varied by vibrating touch surface 116 at different frequencies. Additionally, or alternatively, haptic output device 118 may provide vibrotactile haptic effects, electrostatic friction haptic effects, temperature variation, air puffs, scents, and/or deformation haptic effects along touch surface 116. Some haptic effects may utilize an actuator coupled to the housing (not shown) of computing device 101, and some haptic effects may use multiple actuators in sequence or in concert.

Haptic output devices 118 may use electrostatic attraction or electrostatic friction, for example by use of an electrostatic surface actuator, to simulate a texture on the surface of touch surface 116 or to vary the coefficient of friction the user feels when moving his or her finger across touch surface 116. For example, haptic output devices 118 may be an electrovibrotactile device that applies voltages and currents instead of mechanical motion to generate a haptic effect. In such an embodiment, the electrostatic actuator may include a conducting layer and an insulating layer. In such an embodiment, the conducting layer may be any semiconductor or other conductive material, such as copper, aluminum, gold, or silver. The insulating layer may be glass, plastic, polymer, or any other insulating material. Furthermore, processor 102 may operate the electrostatic actuator by applying an electrical signal to the conducting layer. The electric signal may be an AC signal that, in some embodiments, capacitively couples the conducting layer with an object near or touching touch surface 116.

In some embodiments, the capacitive coupling may simulate a friction coefficient or texture on the surface of touch surface 116. For example, the surface of touch surface 116 may be smooth, but the capacitive coupling may produce an attractive force between an object (e.g., a user's finger or touch) near the surface of touch surface 116. In some embodiments, varying the levels of attraction between the object and the conducting layer can vary the simulated texture on an object moving across the surface of touch surface 116. Furthermore, in some embodiments, an electrostatic actuator may be used in conjunction with traditional actuators to vary the simulated texture on the surface of touch surface 116 or output other effects. For example, the actuators may vibrate to simulate a change in the texture of the surface of touch surface 116, while an electrostatic actuator may simulate a different texture on the surface of touch surface 116.

In some embodiments, an electrostatic actuator may be used to generate a haptic effect by stimulating parts of the body or objects near or touching touch surface 116. For example, in some embodiments, an electrostatic actuator may stimulate the nerve endings in the skin of a user's finger or components in a stylus that can respond to the electrostatic actuator. The nerve endings in the skin, for example, may be stimulated and sense the electrostatic actuator (e.g., the capacitive coupling) as a vibration or some more specific sensation. For example, in one embodiment, a conducting layer of an electrostatic actuator may receive an AC voltage signal that couples with conductive parts of a user's finger. As the user touches touch surface 116 and moves his or her finger along the surface, the user may sense a texture of prickliness, graininess, bumpiness, roughness, stickiness, or some other texture.

Various actuators may be used as haptic output devices 118, and other devices may be used. Haptic output devices 118 may be, for example, an electric motor, an electro-magnetic actuator, a voice coil, a shape memory alloy, an electro-active polymer, a solenoid, an eccentric rotating mass motor (“ERM”), a harmonic ERM motor (“HERM”), a linear resonant actuator (“LRA”), a piezoelectric actuator, a high bandwidth actuator, an electroactive polymer (“EAP”) actuator, an electrostatic friction display, an ultrasonic vibration generator, or macro fiber composite (“MFC”) material. In some instances, the haptic output device may include haptic output drive circuit. In some embodiments, the haptic output device may be unidirectional or bidirectional.

Processor 102 may be one or more general or specific purpose processors to perform computation and control functions of system 100. Processor 102 may include a single integrated circuit, such as a microprocessing device, or may include multiple integrated circuit devices and/or circuit boards working in cooperation to accomplish the functions of processor 102. In addition, processor 102 may execute computer programs, such as an operating system applications stored within memory 104.

In some instances, processor 102 can determine which haptic effects are to be rendered and the order in which the effects are played based on high level parameters. In general, the high level parameters that define a particular haptic effect include magnitude, frequency, and duration. Low level parameters such as streaming motor commands could also be used to determine a particular haptic effect. A haptic effect may be considered “dynamic” if it includes some variation of these parameters when the haptic effect is generated or a variation of these parameters based on a user's interaction. The haptic feedback system in one embodiment generates vibrations or other types of haptic effects on system 100.

Non-transitory memory 104 may include a variety of computer-readable media that may be accessed by processor 102. In the various embodiments, memory 104 may include volatile and nonvolatile medium, removable and non-removable medium. For example, memory 104 may include any combination of random access memory (“RAM”), dynamic RAM (“DRAM”), static RAM (“SRAM”), read only memory (“ROM”), flash memory, cache memory, and/or any other type of non-transitory computer-readable medium.

Network device 110 is configured to transmit and/or receive data with remote sources. Network device 110 may enable connectivity (i.e., communicatively couple) between a processor 102 and other devices by encoding data to be sent from processor 102 to another device over a network (not shown) and decoding data received from another system over the network for processor 102. For example, network device 110 may include a network interface card that is configured to provide wireless network communications. A variety of wireless communication techniques may be used including infrared, radio, Bluetooth, Wi-Fi, other near field communications (NFC) and/or cellular communications. Alternatively, network device 110 may be configured to provide wired network connection(s), such as an Ethernet/Internet connection. For example, haptic feedback determined at haptic effect generation module 128 may be transmitted to one or more remote devices (e.g., a user's mobile phone, smartphone, tablet, wearable watch, smart eyeglasses, and/or other peripheral device) for rendering to the user.

I/O components 112 may be used to facilitate connection to peripheral devices such as one or more displays, keyboards, mice, speakers, microphones, and/or other hardware used to input data or output data, such as a stylus. Storage 114 represents nonvolatile storage such as magnetic, optical, or other storage media included in computing device 101.

Returning to memory 104, illustrative program components 124, 126, and 128 are depicted to illustrate how a device can be configured in some embodiments to provide haptic effects in response to detection of a user or a user's touch, and all other functionality described herein. In this example, detection module 124 configures processor 102 to monitor touch surface 116 via sensors 108 to determine the position of one or more touches. For example, module 124 may sample sensors 108 in order to track the presence or absence of touches. If touches are present, sensors 108 may track one or more of the location, path, velocity, acceleration, pressure and/or other characteristics of the touches.

Haptic effect determination module 126 analyzes data regarding touch or contact characteristics to select haptic effects for rendering. For example, haptic effects may be determined by characteristics of touch surface 116. Alternatively, or additionally, this determination may be made based on characteristics of the touches, such as the location of contact, number of contacts, time of contact, pressure of contact, activity of contact, or features associated with haptic effects. Different haptic effects may be selected based on the location of each touch in order to simulate the presence of a feature by simulating a texture on a surface of touch surface 116 or generally another type of haptic effect.

Haptic effect generation module 128 is configured to cause processor 102 to generate and transmit haptic signals to haptic output devices 118. For example, generation module 128 may access stored waveforms or commands to send to haptic output devices 118. As another example, haptic effect generation module 128 may receive a desired type of texture and utilize signal processing algorithms to generate an appropriate signal to send to haptic output devices 118. As yet another example, a desired texture may be indicated along with target coordinates for the texture and an appropriate waveform sent to one or more actuators to generate appropriate displacement of touch surface 116 (and/or other device components).

Although shown as a single system, the functionality of system 100 may be implemented as a distributed system. For example, system 100 may be part of a device (e.g., an electronic billboard, printable media, tablet, mobile phone, smartphone, tablet, wearable watch, smart eyeglasses, personal computer, console, video game console, and/or other peripheral device.), and system 100 may provide haptic effect functionality for the device. In another example, system 100 may be separate from the device, and may remotely provide the aforementioned functionality for the device.

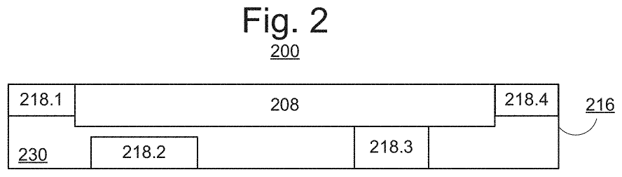

FIG. 2 illustrates a cross-sectional view 200 of a haptic enabled display surface 216 according to an example embodiment of the present invention.

As shown in the example embodiment of FIG. 2, display surface 216 may include sensors 208, a plurality of haptic output devices 218.1-218.4, and a substrate 230. Haptic output devices 218.1-218.4 may be integrally formed as part of substrate 230. Additionally, or alternatively, haptic output devices of the corresponding host device or remote device may be used. It should be understood that numerous configurations of sensors 208 and haptic output devices 218.1-218.4 are feasible, and that the configuration depicted in FIG. 2 is only one example configuration. For example, display surface 216 may be equipped without sensors 208 and configured to periodically or continuously render one or more haptic effects. In another example, display surface 216 may be configured as a touch display or touch screen that is configured to receive user input according to a user's touch and to render haptic feedback at one or more locations of the touch-enabled display. Furthermore, it should be understood that each of the haptic output devices may include one or more actuators and/or one or more of any of the other haptic output devices described herein.

Display surface 216 may be part of a variety of electronic devices. For example, display surface 216 may be part of an electronic billboard, printable media, tablet, mobile phone, smartphone, tablet, wearable watch, smart eyeglasses, personal computer, console, video game console, and/or other peripheral device. The one or more haptic effects rendered by these devices may include a variety of haptic effects including vibrations, vibrotactile, textures, deformations, friction, electrostatic friction, temperature or thermal, ultrasound, smart material, air jets, scents, etc. The haptic effects may be applied to the entire display surface 216, may be localized to particular portions or positions of display surface 216, or may be applied in one or more positions near or adjacent to display surface 216.

In electronic billboard embodiments, the increased size and fixed location provides numerous configurations. In addition to embedding haptic capabilities into the display (e.g., an advertisement displayed on a screen or glass) of display surface 216 at one or more positions where the user interacts, one or more external modules or devices also may be utilized so that a user may further interact with the billboard content (e.g., an advertisement, product display, corporate logo, etc.). For example, a user may feel a haptic effect on his/her finger while engaging (e.g., touching or being adjacent to) with display surface 216 where an advertisement is displayed. In addition, or in the alternative, one or more external modules or devices may be configured to provide further haptic feedback. For example, the electronic billboard may be configured to connect with remote devices such as mobile phones, smartphones, or wearable devices of one or more nearby users passing by the electronic billboard. The electronic billboard may connect to the user's one or more devices through Bluetooth or another near field communications (NFC) technology. In another example, the external modules or devices may include one or more additional force feedback platforms, such as air jets or surface overlays. Haptic effect control signals may be supplied by the electronic billboard directly, and/or a command signal may be supplied to cause the external modules or devices to download the haptic control signal (e.g., download from a cloud-based storage device). In some instances the billboard content also may be provided directly on the remote devices. In other words, the advertisement and the haptic feedback may be provided at the electronic billboard, the remote devices, or any combination thereof.

In various configurations of display surface 216, the number and positions of haptic output devices may be adjusted to render customized haptic feedback as well as to provide configurations for numerous advertisement types. In yet other configurations, an add-on layer, overlay, or other add-on hardware device may be physically or communicatively coupled to display surface 216 to provide the haptic feedback and/or supplemental haptic feedback.

One or more haptic effects may be provided in response to a user's touch and/or a user's proximity, as detected by sensor 208. For example, the haptic effect may be rendered in response to the user's touch at a portion of display surface 216, a user's proximity (e.g. within 3 feet or 5 feet) to display surface 216, and/or a user walking or otherwise passing in front of display surface 216. Alternatively, or additionally, the haptic effect may be provided without any user input. For example, the haptic effect may be provided as part of the advertisement content itself, especially in the case of animated content.

Sensors 208 may be configured to detect a user input through touch sensing on display surface 216 (e.g., capacitive, resistive, infrared, and other types of sensing), and/or through sensed gesture or sensed presence of the user that may be detected by acoustic sensing, computer vision, infrared sensing, Lidar, and/or other types of sensing. In some configurations, sensors 208 may be configured to detect the eye gaze of the user so as to track where he/she is looking and to render the one or more haptic effects according to the user's detected eye gaze. Additionally, or alternatively, sensors 208 may be configured to facially recognize the user, and to render the one or more haptic effects according to the user preferences or user profile of the identified user.

Haptic output devices 218.1-218.4 may be configured to render a variety of haptic effects. Example haptic effects include vibrations, vibrotactile, textures, deformations, friction, electrostatic friction, temperature or thermal, ultrasound, smart material, air jets, scents, etc. The haptic effects may be applied to the entire display surface 216 or may be localized to particular portions or positions of display surface 216. The haptic effects associated with the display of display surface 216 (e.g., an advertisement or other media content) may be predetermined. That is, the haptic effects corresponding to the display may be designed in advance by a human curator. Alternatively, the haptic effects may be generated automatically by analyzing the content itself (i.e., audio and video analysis and conversion to one or more haptic effects, haptic instructions, or haptic streams).

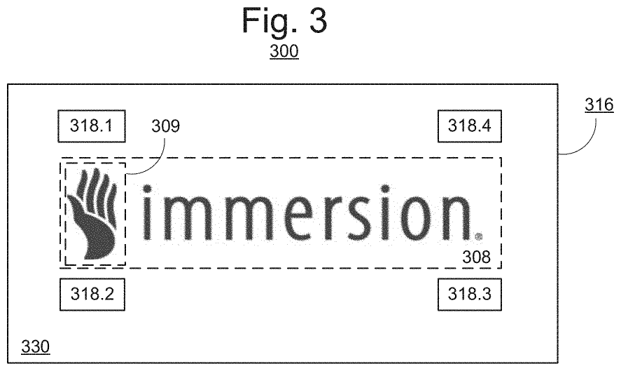

FIG. 3 illustrates a front view 300 of a haptic enabled media surface 316 according to an example embodiment of the present invention.

As shown in FIG. 3, media surface 316 includes sensors 308, a plurality of haptic output devices 318.1-318.4, and a substrate 330. Haptic output devices 318.1-318.4 may be integrally formed as part of substrate 330. It should be understood that numerous configurations of sensors 308 and haptic output devices 318.1-318.4 are feasible, and that the configuration depicted in FIG. 3 is only one example.

In this example embodiment, sensors 308 and haptic output devices 318.1-318.4 may jointly comprise one or more smart materials. Such smart materials include, for example, piezoelectric materials that are configured to produce a voltage signal in response to an applied stress; shape-memory alloys and shape-memory polymers that are configured to produce a deformation in response to a change in temperature or stress; or temperature-responsive polymers that are configured to change shape in response to a temperature change (e.g., temperature change detected by a user's touch). Accordingly, it is understood that such smart materials may comprise both sensors 308 and haptic output devices 318.1-318.4. However, other configurations are also feasible.

Substrate 330 may include paper and/or any other printable material, such as a three-dimensional printable material. For example, paper advertisements (e.g., such as those found in magazines, journals, etc.) may be configured to provide a printed texture to the advertisement that represents the texture of the advertised product or its effect. For example, a texture of soft and smooth hair may be provided adjacent to a texture of rough and damaged hair in a shampoo advertisement. In some configurations, such textures may be programmable and may be varied in response to the user's interaction. Returning to the shampoo advertisement example, the user may first feel the smoothness of simulated hair on substrate 330 and when passing his/her hand again on substrate 330, such as at portion 309, the texture may be varied to simulate rough and damaged hair. The changing texture can be realized by using smart materials or electrostatic friction, for example.

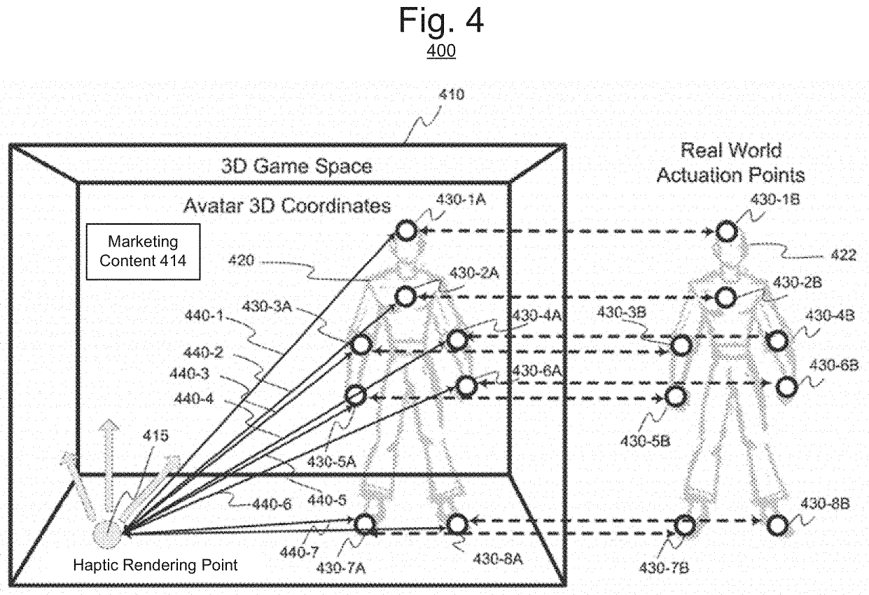

FIG. 4 illustrates the rendering of haptic effects in an alternate reality environment according to an example embodiment of the present invention. Here, “alternate” reality is used to refer collectively to augmented reality and virtual reality embodiments.

Haptic generation system 400 illustrates a three-dimensional alternate reality space 410 that includes a marketing content 414 (e.g., a marketing video or static marketing content/image), a haptic rendering point 415, an avatar 420 in the three-dimensional alternate reality space and a corresponding user 422 in the real world. Avatar 420 is shown with sample actuation points 430-1A through 430-8A. The avatar's actuation points correspond to real world actuation points on user 422 shown as 430-1B through 430-8B. Further, vectors 440 indicate the direction and distance from haptic rendering point 415 to each of the avatar actuation points 430-1A-430-8A.

Haptic generation system 400 renders one or more haptic effects at marketing content 414 and/or haptic rendering point 415 (e.g., an external haptic feedback module, such as an air jet, a surface overlay, or an ultrasound patch). System 400 subsequently specifies the absolute coordinates of haptic rendering point 415 in the three-dimensional alternate reality space 410, or calculates vectors 440-1-440-7 to determine a relative distance from haptic rendering point 415 to each actuation point 430-1A-430-8A on avatar 420. Vectors 440-1-440-7 also may represent intensity from haptic rendering point 415 to each of the actuation points on avatar 420. System 400 also may include a spatial propagation span that defines the intensity of haptic rendering point 415 based on the distance from the event.

System 400 illustrates the user's three-dimensional status. User 422's position and orientation in the three-dimensional alternate reality space 410 as shown by avatar 420 can be provided directly by a three-dimensional video engine (not shown). In another embodiment, user 422's three-dimensional location and orientation in the real world can be accomplished using a multitude of sensors such as accelerometers, gyroscopes, RFIDs, optical tracking, etc. Location and gesture information of user 422 is tracked or otherwise provided to system 400. User 422's status may include the three-dimensional position in an absolute or relative referential coordinates and may refer to the location of user 422 or be more localized by referring to the location and orientation of multiple body parts, or to the location of each actuation point (e.g., 430-1B 430-8B).

System 400 is configured to provide a variety of haptic effects, and is further configured to analyze characteristics of marketing content 414, haptic rendering point 415, the user's status, and/or the available or functionality of the haptic output devices. According to these characteristics, system 400 generates one or more haptic effects. The haptic effects may include a combination of one or more haptic cues delivered to the user such as vibrations, vibrotactile, textures, deformations, friction, electrostatic friction, temperature or thermal, ultrasound, smart material, air jets, scents, etc. In addition, system 400 may generate a haptic effect with specific characteristics, such as a type of haptic cue, frequency, duration, and magnitude or intensity.

The haptic effects can be generated in real-time and played back along the three-dimensional video, during game-play, and/or partially offline (i.e., saved in a timeline/track embedded to the video or separate) as the system can generate partial effects in advance given some known characteristics of the event (e.g., type of the effect) and then generate the final effect to be displayed given the user's relative location to the event.

In system 400, user 422 may utilize wearable smartglasses or another type of head-mounted display (not shown). Through the head-mounted display, user 422 explores the alternate reality space and may encounter marketing content 414 (e.g., two-dimensional or three-dimensional advertisements, video, static media, etc.). Marketing content 414 may be enhanced with one or more haptic effects, as described above. The haptic effects may be rendered in response to a user looking at marketing content (e.g., determined using eye-gaze techniques), a user/avatar touch of marketing content 414, or user/avatar proximity to marketing content 414.

Marketing content 414 may be augmented with one or more haptic effects that differ in nature and magnitude according to the user's position and orientation in the three-dimensional space and/or the nature of the three-dimensional content. The haptic effects may be provided in response to interactions (e.g., touch, virtual touch, passing by, proximity, etc.) of user 422 and/or avatar 420 with marketing content 414.

For example, the haptic effects may be rendered at any wearable or mobile device of user 422. In some instances, user 422 wears a haptic glove, smartglasses, and/or other wearable device such that haptic feedback is rendered in the real physical environment of user 422 (e.g., using ultrasound patches).

The position or gestures of user 422 or avatar 420 in the alternate reality space may be estimated using any of the sensing techniques described above and/or provided directly through a three-dimensional environment engine (not shown). In some instances, the alternate reality interaction devices (e.g., joysticks, head mounted displays, etc.) provide the sensed position or gesture data.

As shown in FIG. 4, user 422 or avatar 420 is presented with marketing content 414. The visual, auditory, and haptic features marketing content 414 may be varied according to the user/avatar point of view, user preferences, distance from marketing content 414, and/or interactions with marketing content 414 (e.g., touching different portions of marketing content 414). In some instances, the haptic feedback may be localized in three dimensions such that a plurality of devices provides haptic feedback, including different types of haptic feedback, to respective portions of user 422. For example, an advertisement for coffee may include a virtual cup of coffee that user 422 may feel or smell when interacting with the cup. In another example, user 422 may further feel the coffee beans or grounds when interacting with the coffee advertisement. In some instances, the distance of user 422 to marketing content 414 and/or haptic rendering point 415 may vary the haptic feedback. In another example, marketing content 414 may be moving in a way to convey different haptic sensations to the user/avatar over time (e.g., a three-dimensional rotating banner alternating hot and cold air).

In some instances, system 400 may be configured to provide a tactile cue to be added to the visual clues in the alternate reality space. For example, marketing content 414 may be overlaid on a real surface or displayed as hologram (e.g., mid-air). In the case of mid-air interactions, for example, the haptic effects may be rendered using air puffs, ultrasound, vibrotactile effects, etc. through a wearable device (e.g., wrist wearable), or a smart interaction device (e.g., glove, controller etc.). This interaction device can be rigid (e.g., a plastic controller) or flexible (e.g., a fabric glove) in communication with one or more alternate reality modules. In the case of surface overlay, a surface with haptic feedback capabilities (e.g., vibrotactile, deformation, variable texture, variable stiffness, electrostatic friction, friction change by piezoelectric material, etc.) may be provided. For example, the surface may change its shape (e.g., using bi-stable material, shape-memory alloy, etc.), stiffness (e.g., jamming), its friction at touch (e.g., using electrostatic friction, ultrasound, piezoelectric material), and/or a vibrotactile effect (e.g., EAP, MFC) may be provided so as to enhance the visual overlay.

In some instances, the surface is provided using one or more overlays. Here, the overlay surface is equipped with a communication module (e.g., Bluetooth, NFC, tethered, wireless) that enables it to receive commands or haptic instructions. The surface on which an overlay is provided may be any size, shape, or material (e.g., fabric, plastic, metal, wood, etc.). In addition, the surface may be a dedicated object for one or more overlays or it can be any piece of furniture in the user's alternate reality environment (e.g., desk, chair, table, wall, etc.). For example, in a furniture showroom, a standard neutral dining table may be provided with different overlays of visual materials (e.g., different species of wood, metal, glass, different colors, different finishes, etc.) that enable a customer user to visualize a wider array of product offerings. Here, alternate reality and haptic feedback enables the simulation different product offerings by changing the friction on the overlay table (e.g., simulate shiny or matte varnish). Moreover, the haptic feedback may be independent of a specific surface rendered using an overlay so as to not interfere with the visual overlay.

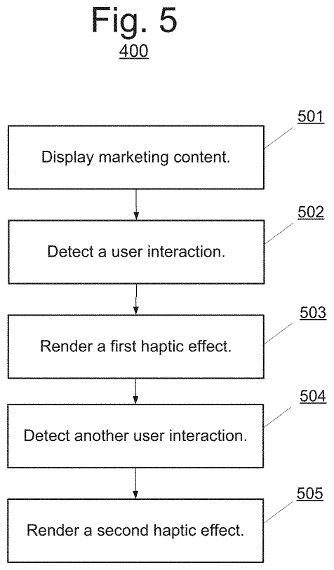

FIG. 5 illustrates a flow diagram of functionality 500 for rendering haptic feedback in connection with marketing content according to an example embodiment of the present invention. In some instances, the functionality of the flow diagram of FIG. 5 is implemented by software stored in memory or other computer readable or tangible media, and executed by a processor. In other instances, the functionality may be performed by hardware (e.g., through the use of an application specific integrated circuit (“ASIC”), a programmable gate array (“PGA”), a field programmable gate array (“FPGA”), etc.), or any combination of hardware and software.

At the outset, functionality 500 displays marketing content to one or more users, at 501. For example, the marketing content may be displayed on a display that may or may not be configured to receive touch user input, or the marketing content may be displayed on printable media. The display or touch enabled display may be provided at any of the electronic devices described herein.

Next, at 502, functionality 500 detects one or more user interactions, such as a first user interaction. For example, user interactions may be detected using one or more sensors as described herein in connection with FIGS. 1-4. For example, one or more sensors may be configured to detect a user input through touch sensing on touch surface (e.g., capacitive, resistive, infrared, and other types of sensing), and/or through sensed gesture or sensed presence of the user that may be detected by acoustic sensing, computer vision, infrared sensing, Lidar, and/or other types of sensing.

Next, functionality 500 renders one or more haptic effects, such as a first haptic effect, to a user in response to the detected user interaction, at 503. A variety of haptic effects may be rendered including vibrations, vibrotactile, textures, deformations, friction, electrostatic friction, temperature or thermal, ultrasound, smart material, air jets, scents, etc. The haptic effects may be applied to the display of the marketing content or may be localized to particular portions or positions of the marketing content.

In some configurations, sensors may be configured to detect the eye gaze of the user so as to track where he/she is looking and to render the one or more haptic effects according to the user's detected eye gaze. Additionally, or alternatively, sensors may be configured to facially recognize the user, and to render the one or more haptic effects according to the user preferences or user profile of the identified user.

At 504, functionality 500 detects one or more user interactions, such as a second user interaction. Lastly, at 505, functionality 500 renders one or more haptic effects, such as a second haptic effect, to a user. In some instances, the one or more haptic effects may be rendered in response to the detected second user interaction.

A number of use cases will now be described. In a first example use case, a user is walking past an electronic billboard (e.g., in a shopping mall) that is advertising a juicy fruity chewing gum. Using information from the user's device (e.g., mobile phone, smartphone, wearable device, etc.), the electronic billboard may call out to the user by name. Upon turning to the electronic billboard, the user may be greeted by an image of an attractive person moving towards the user (i.e., displayed on the screen) and blowing a kiss to the user. While the user is blown a kiss, an air jet is configured to release scented air to convey the juicy fruity chewing gum.

In a second example use case, a user is intrigued by a dynamic/animated billboard that poses the question: “which toilet paper would you prefer to use? Come and touch by yourself.” In response to the user putting a hand on the indicated space, the user feels a rough surface (e.g., created by using electrostatic friction). The rough surface is identified as a competing brand by the electronic billboard. In turn, the user feels a smooth and soft surface after a few moments. After the user feels a smooth soft surface on the same spot (e.g., by changing the texture rendered by the electrostatic friction), the electronic identifies the advertised product.

In a third example use case, a user is checking a news site on a tablet device. In connection with the news site, an advertisement for bio-active yogurt is displayed to the user. The advertisement invites the user to feel a bloating belly (e.g., replicated through screen deformation), and the invites the user to feel a non-bloated belly that occurs after drinking the bio-active yogurt.

One having ordinary skill in the art will readily understand that the invention as discussed above may be practiced with steps in a different order, and/or with elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A system comprising:
a processor;
a display;
a non-transitory memory storing one or more programs for execution by the processor, the one or more programs including instructions for:
displaying marketing content on the display;
detecting a user interaction at or adjacent to the display; and
rendering a haptic effect that corresponds to the marketing content, wherein the haptic effect is rendered at a user device that is communicatively coupled to the system.

2. The system according to claim 1, further comprising:
one or more sensors configured to detect a presence of a user.

3. The system according to claim 2, wherein the one or more sensors are configured to further detect an eye gaze of the user such that the haptic effect is rendered according to the eye gaze of the user.

4. The system according to claim 2, wherein the one or more sensors are configured to facially recognize the user and to render the haptic effect according to a user preference or user profile of the user.

5. The system according to claim 1, wherein the haptic effect is rendered according to a user preference or user profile of the user.

6. The system according to claim 1, wherein the marketing content and the haptic effect are rendered in connection with the alternate reality environment.

7. The system according to claim 1, wherein the first haptic effect includes one or more of a vibrotactile haptic effect, an electrostatic friction haptic effect, a temperature variation, an air puff, a scent, and a deformation haptic effect.

8. A method for rendering a haptic effect, the method comprising:
displaying marketing content on a touch display;
detecting a user interaction at or adjacent to the touch display; and
rendering a haptic effect that corresponds to the marketing content,
wherein the haptic effect is rendered at a user device that is communicatively coupled to the touch display.

9. The method according to claim 8, wherein one or more sensors are configured to detect a presence of a user.

10. The method according to claim 9, wherein the one or more sensors are configured to further detect an eye gaze of the user such that the haptic effect is rendered according to the eye gaze of the user.

11. The method according to claim 9, wherein the one or more sensors are configured to facially recognize the user and to render the haptic effect according to a user preference or user profile of the user.

12. The method according to claim 8, wherein the haptic effect is rendered according to a user preference or user profile of the user.

13. The method according to claim 8, wherein the marketing content and the haptic effect are rendered in connection with the alternate reality environment.

14. The method according to claim 8, wherein the first haptic effect includes one or more of a vibrotactile haptic effect, an electrostatic friction haptic effect, a temperature variation, an air puff, a scent, and a deformation haptic effect.

15. A non-transitory computer readable storage medium storing one or more programs configured to be executed by a processor, the one or more programs comprising instructions for:
displaying marketing content on a touch display;
detecting a user interaction at or adjacent to the touch display; and
rendering a haptic effect that corresponds to the marketing content,
wherein the haptic effect is rendered at a user device that is communicatively coupled to the touch display.

16. The non-transitory computer readable storage medium according to claim 15, wherein one or more sensors are configured to detect a presence of a user.

17. The non-transitory computer readable storage medium according to claim 16, wherein the one or more sensors are configured to further detect an eye gaze of the user such that the haptic effect is rendered according to the eye gaze of the user.

18. The non-transitory computer readable storage medium according to claim 16, wherein the one or more sensors are configured to facially recognize the user and to render the haptic effect according to a user preference or user profile of the user.

19. The non-transitory computer readable storage medium according to claim 15, wherein the haptic effect is rendered according to a user preference or user profile of the user.

20. The non-transitory computer readable storage medium according to claim 15, wherein the marketing content and the haptic effect are rendered in connection with the alternate reality environment.
